(19) United States
(12) Patent Application Publication
(10) Pub. No.: US 2018/0222795 A1
(43) Pub. Date: Aug. 9, 2018

(54) Method and Device for the Thermal Treatment of Sand

(71) Applicant: Technische Universität Dresden, Dresden (DE)

(72) Inventors: Frank Neumann, Dresden (DE); Manfred Curbach, Dresden (DE)

(21) Appl. No.: 15/747,154

(22) PCT Filed: Jul. 27, 2016
(86) PCT No.: PCT/DE2016/100340

§ 371 Date: Jan. 24, 2018

(30) Foreign Application Priority Data
Jul. 28, 2015 (DE) 10 2015 112 282.0

(51) Int. Cl. C04B 18/02; G02B 19/00; G02B 3/08; B28B 11/24; C04B 14/06; F24S 20/30; F24S 23/30; F24S 30/00; F24S 70/16

(52) U.S. Cl. CPC C04B 18/023; G02B 19/0042; G02B 19/0009; G02B 3/08; B28B 11/243; C04B 2111/0025; F24S 20/30; F24S 23/30; F24S 30/00; F24S 70/16; C04B 14/06

(57) ABSTRACT

The invention relates to a method and an apparatus for sintering sand. An object of the invention consists in using energy-saving sintering to make it possible to use round-grain sand with evenly distributed grain fractions as a building material, and particularly as an aggregate.

The object is achieved by providing a focusing device (3) for thermal energy-rich radiation (2) for generating at least one focal point (5) on the surface of a bulk sand (10) and a positioning device (6) for continuous relative movement between the focal point (5) and the sand (10).

The object is further achieved by using desert sand as an aggregate for a construction element (12), characterized in that grain agglomerates (11) of desert sand (10) obtained by sintering are introduced as an aggregate into a matrix material (13).

### CROSS REFERENCE TO RELATED APPLICATIONS

This application is the U.S. national stage of International Application No. PCT/DE2016/100340, filed on 2016 Jul. 27. The international application claims the priority of DE 102015112282.0 filed on 2015 Jul. 28; all applications are incorporated by reference herein in their entirety.

### BACKGROUND

The invention relates to a method and an apparatus for the thermal treatment of sand, for example sintering, and an aggregate or reinforcement material so obtained for the construction industry, for example for concrete or asphalt. The source material is in particular round-grain sand with evenly distributed grain fractions, for example desert sand. No binders need to be added since the bonding between the sand grains is achieved through an at least temperature-induced modification of the material. Pressure influences may additionally be used. In the case of solid phase sintering, the temperature mostly remains below the glass or melting temperature of the component with the lowest melting point. In the case of liquid phase sintering, the temperature is above the glass transition or melting temperature, so that the material then changes to the liquid state.

Sand can be extracted from dry deposits (dry extraction) or from moist deposits such as lakes, rivers or sea beds (moist extraction). Access to these deposits is limited and extraction is cost and time consuming and, in addition, harms the ecosystem of the respective extraction area. Desert sand, by contrast, is readily available and easy to extract, however, due to its round-grain shape and its uniform grain size, it is unsuitable for use as a building material and also hard to use as an aggregate for the preparation of concrete and concrete products.

Numerous methods are known for sintering sand in order to make fireclay bricks for furnaces. However, all these methods require a binder.

As an alternative solution, the desert sand grains can be sintered or fused (although melting would result in vitrification and thus in a considerable loss in strength), which can also be done without binders. Such products are known from the prior art. Document DE 12 13 092 A proposes an aggregate for the construction industry which may also be based on sand and devitrified glasses and which is made by melting in a rotary kiln. A rotary kiln requires a large amount of energy for operation and, unless additional protective measures are taken, is heavily worn when melting sand.

Document DE 32 48 537 A1 particularly addresses the problem involved in the use of desert sand upon preparation of a sintered molded part. Here, the molded part made of loose sand is kept in its desired shape through an electric field. If the final product needed is a coarse-grain aggregate, the molded parts produced by sintering in a furnace are crushed so as to obtain different grain diameters, for example 0 to 2 mm (sands) or 2 to 63 mm (gravels). This is disadvantageous in that the material is first agglomerated, which consumes a large amount of energy, and is then subsequently destroyed, which incurs additional energy consumption, in order to obtain the desired product. Moreover, shaping using an electric field involves large efforts in terms of facilities and processes.

### SUMMARY

The invention relates to a method and an apparatus for sintering sand. An object of the invention consists in using energy-saving sintering to make it possible to use round-grain sand with evenly distributed grain fractions as a building material, and particularly as an aggregate.

The object is achieved by providing a focusing device (3) for thermal energy-rich radiation (2) for generating at least one focal point (5) on the surface of a bulk sand (10) and a positioning device (6) for continuous relative movement between the focal point (5) and the sand (10).

The object is further achieved by using desert sand as an aggregate for a construction element (12), characterized in that grain agglomerates (11) of desert sand (10) obtained by sintering are introduced as an aggregate into a matrix material (13).

### DETAILED DESCRIPTION

An object of the present invention thus consists in using an energy-saving thermal treatment to make it possible to use round-grain sand with evenly distributed grain fractions as a building material, and particularly as an aggregate.

The object is achieved by a method for the thermal treatment of sand, wherein a radiation focused to at least one focal point is used which is directed onto a surface of a bulk of the sand. While every mirror or lens can have only one focal point, the invention provides for the use of complex mirrors or lenses, which have multiple focal points and are designed as lens systems. With respect to the radiation focused to a focal point, any radiation can be used that creates heat when meeting a surface such as the sand. Solar radiation is preferred for this.

Here, the radiation is so intense that the local temperature of the sand is increased to such an extent that, once the sintering temperature of at least the component with the lowest melting point is reached, the crystal lattice structure of the SiO₂ compounds changes, and/or changes in shape and/or grain connections, hereinafter referred to as grain agglomerates, are created or occur. Sand does not homogeneously consist of SiO₂ but constitutes a mixture of components with different melting temperatures, which varies depending on its origin.

The change in the crystal lattice structure here occurs at least at the surface of the sand grains. This is because according to a preferred embodiment of the invention the sand grain does not need to be sintered or melted completely; instead, it is in this case already sufficient to slightly “disintegrate” the crystal structures at the surface. As a result, the surface of the sand grain is expanded and roughened, so that in the use as an aggregate a stronger bonding with the matrix material, for example concrete, is achieved. It has shown to be particularly advantageous if the sand grain is not melted completely. In this manner, the strength provided by the crystalline structure is maintained. If the sand grain is melted completely, its structure becomes amorphous and brittle.

A further effect changes the shape of the sand grain from a rounded to an irregular or compact form such that the sand grain can be reliably embedded in the matrix material in a type of form closing bond able to withstand higher loads. Furthermore, the modification of the surface serves as a preparation for subsequent sintering, after which the surfaces of two or more grains can adhere to one another. This is preferably implemented through a multi-stage method.

For free sintering, the focal point and/or the sand are guided relative to one another on such a path and at such a speed that grain agglomerates having the intended dimensions are created. According to an alternative embodiment of the method, the free sintering is carried out with a focal point which is stationary relative to the sand and has a steady orientation.

An alternative to this consists in mold sintering, in which the focal point is directed in a suitable manner, particularly statically or movably, onto the bulk of the sand introduced into a temperature resistant sintering mold which is open towards the top. This produces grain agglomerates having the intended dimensions, so that a molded part is formed. The shape of the molded part then corresponds to the negative shape of the sintering mold. It may be shaped, for example, as a cuboid, pyramid or tetrahedron. To facilitate removal of the molded part from the mold, the sintering mold may include an ejection channel arranged opposite the open side, through which the molded part is ejected after curing and which is closed with a screw, for example, during filling and sintering. Just like the sand in the case of free sintering, the mold may be moved through the apparatus on a conveyor device.

Achieving the object of the invention requires a method for modifying solid matter properties. In such a method, the surface structure of sands, particularly desert sands, is changed such that, on the one hand, the surface appearance of an individual grain changes and, on the other hand, multiple (desert) sand grains can be joined together to form a grain conglomerate, hereinafter referred to as a grain agglomerate, of variable size.

During initial sintering, the crystal lattice structure is preferably partially disintegrated at the surface of the sand due to the heat supplied. During a subsequent second sintering operation, this amorphous phase, which accordingly no longer has a crystalline structure, is heated at the surface until reaching the glass transitional temperature so that it agglomerates with equally pretreated sand grains.

The properties of the sands, particularly desert sands, are selectively modified through sintering processes. The high energy demand of sintering processes is in this case met through the use of solar energy. As a result of the sintering process, the crystal lattice structure of the SiO₂ compounds changes and, through individually adapted sintering temperatures, enables deformation and grain agglomerates.

An advantageous embodiment of the method according to the invention comprises a selective and timed reduction of the temperature, particularly after the sintering operation, so that the crystal lattice structure of the SiO₂ compounds is selectively influenced further.

As a result of the increase in temperature caused by the energy input, the crystal lattice structure is selectively influenced, and particularly also disintegrated. The structure changes from crystalline (ordered) to amorphous (disordered). This change is also referred to as vitrification. The latter is also directly correlated with the degree of brittleness. Consequently, a desired structure of the lattice of the material can be created or, by doing so, a specific degree of brittleness can be obtained for the material. In a manner similar to steel hardening, the lattice structure can be selectively influenced through selective temperature reduction within a specific period, for example quick or slow cooling or quenching, and under observation of the critical cooling rate.

The method is preferably carried out using multiple focusing devices, preferably multiple lenses, which successively supply a focused radiation to the surface of the sand, whereby the local temperature is increased stepwise or constantly or decreased in a controlled manner. The focusing is not necessarily achieved solely through the lens system.

The created first grain agglomerates are advantageously subjected to thermal treatment at least once more, so that the first grain agglomerates join together through sintering to form larger second grain agglomerates, and different grain sizes and/or granulates are formed. In this manner, an aggregate similar to gravel can be formed, which is suitable for various applications. Different sieve curves can be achieved by mixing different grain sizes. Through the use of the first grain agglomerates, freely shaped, larger grain agglomerates may obtain an open and rough surface.

The grain agglomerates are advantageously separated according to grain size. In this manner, material for different applications can be obtained. The desired sieve curve can then be obtained through selective mixing of different grain sizes.

A device for the utilization of solar energy which provides thermal energy obtained through focused solar radiation is particularly advantageous. A focusing device, which is preferably designed as a lens system, focuses the solar radiation, preferably also in a controlled manner, so that the temperature at the focal point of the lens or lens system is adjustable, preferably continuously. This allows for carrying out the method using a renewable energy source instead of other, expensive energy sources. The focal point of a lens system may differ from that of a single lens.

In order to dose the amount of energy used, the focused solar radiation is adjustable through a device which modifies the cross-section of the beam, for example a lamellar aperture, or through the use of the so-called shutter technology, in which the duration of exposure is changed by fully allowing and obstructing passage of the beam in alternating, sequential intervals at a predetermined frequency. Other methods or measures influencing the intensity of the amount of energy usable at the focal point are also comprised by the invention. In this manner, the sintering operation can be controlled such that it is avoided that the created bonds are too weak, or the sand is melted to a too large extent. Through this, the temperature at the focal point of the lens, the lens system or any other focusing system, can be adjusted variably and continuously. Other control and adjustment systems for adapting the intensity at the focal point, which are adapted to the respective energy source and focusing system, are also comprised by the invention.

The object of the invention is further achieved by an apparatus for sintering sand, wherein a focusing device for thermal energy-rich radiation for generating at least one focal point on the surface of a bulk sand and a positioning device for continuous relative movement between the focal point and the sand are provided. The focusing device provides for collimation of the beam such that, on the one hand, the sand is exposed to thermal radiation having a high local concentration, so that energy in the form of heat caused by radiation, preferably solar radiation, acts on the sand. On the other hand, a relatively small area of the bulk is heated. This ensures controlled shaping of the grain agglomerates, so that freely shaped, sintered grain agglomerates can be produced.

A device for utilizing solar energy is preferably provided which advantageously comprises a lens system for focusing and focuses the solar radiation in a controlled manner, for example through an aperture, such that the temperature at the focal point of the lens is variably and continuously adjustable. This ensures compliance with the temperature range to be observed for the intended sintering process depending on the feed rate.

According to a preferred embodiment, the lens system comprises a Fresnel lens, thus enabling a space-saving design, and particularly a low depth of the lens system. Furthermore, an aperture is provided, which is preferably designed as a lamellar aperture. A shutter arrangement is alternatively provided. Both devices serve to control the intensity of the focused solar radiation as needed.

In an alternative embodiment, multiple focusing means or lenses are provided. These are arranged in such a manner that the temperature of the sand can be changed stepwise or constantly during the continuous relative movement between the focal point and the sand. An arrangement of multiple focusing devices or lenses in a row is preferred. It is further advantageous to provide a metering device which applies the sand to a heat resistant, preferably ceramic, conveyor device. Due to the arrangement of multiple focusing devices or lenses, the temperature can be increased stepwise or constantly or decreased in a controlled manner during the conveyance or transport of the raw material.

Another solution according to the invention relates to a reinforcement material comprising sintered round-grain sand, wherein according to the invention sand grains as source material are agglomerated to form grain agglomerates of a predetermined size or size distribution.

Grain agglomerates shaped in a load and/or geometry dependent manner are particularly advantageous and also comprised by the invention. Further provided are three-dimensional bodies, and even hollow bodies, designed as a single- or multi-layer lattice or space lattice with variable lattice parameters.

The advantages of the invention become particularly apparent if desert sand is provided as the round-grain sand, which is the raw material for the method according to the invention. Through this, as another aspect of the solution according to the invention, it becomes possible to use desert sand as an aggregate for a construction element, wherein desert sand grain agglomerates obtained through sintering are introduced as an aggregate into a matrix material.

Specified geometries of the sintered raw material, i.e., the grain agglomerates, can be obtained by following the principle of free sintering. Through directionally oriented incorporation of the sintered, freely shaped material, a relevant volume fraction thereof can be oriented towards those areas which are subjected to less tensile stress. The grain agglomerates may also be shaped such that they support each other inside the matrix material and form a large volume that will not collapse.

A particularly advantageous result is obtained if the sintered and direction-wise freely shaped grain agglomerates are incorporated in the matrix material in a directionally oriented manner. It thus becomes possible that, at a constant volume ratio of the aggregate and the matrix material, the grain agglomerates are oriented in that direction of the construction element that is subjected to less tensile stress. At the same time, due to the aggregate, the reduction of the cross-sectional area of the matrix material, for example concrete, is smaller in the direction of tension than in the direction of compression. For example, if rod-shaped grain agglomerates are introduced into the concrete, given an equal volume of the aggregate of, for example, rounded grains, the concrete matrix will have a larger cross-sectional area in the longitudinal direction of the rods. In the transverse direction, on the other hand, the cross-sectional area of the concrete matrix is much smaller. Therefore, the transverse direction is chosen such that it is aligned with the compressive load, whereas the longitudinal direction is aligned with the tensile load. Concrete has a considerably lower strength in the tensile direction, which can be compensated for at least partially through an aggregate shaped in the described manner and introduced in a directionally oriented manner.

The relevant strength of the concrete is determined by the matrix, i.e., the hydrated cement, wherein the tensile strength corresponds to only a fraction, for example about 10%, of the compressive strength. Mineral aggregates are added as so-called fillers or aggregates in order to obtain an optimal bulk density of the mineral aggregates and thus to keep the cement proportion low. Besides higher costs, a larger amount of cement results in a higher demand for mixing water and thus a higher total demand for water. This causes a higher shrinkage tendency, mixture separation, pore formation, etc.

It is an object of the invention to orient the volume fractions of the aggregates in the matrix according to required loads and dimensions and such that the water/cement/aggregate ratio remains unchanged. For concretes in which the strength of the hydrated cement is higher than that of the mineral aggregates (which is generally the case with HPC and UHPC), the mineral aggregates should rather be oriented in the direction of compression. For normal strength concretes, it can be assumed that the mineral aggregates have a higher tensile strength than the matrix. Thus, mineral aggregates according to the invention which are oriented in the direction of tension can be understood as a reinforcement.

Particularly useful applications may be floor tiles, industrial floors or floor screeds that are reinforced to withstand high mechanical stresses, similar to a fiber reinforcement.

It is therefore likewise advantageous if the grain agglomerates are shaped such that the elements of the aggregate support each other in the matrix material and thus form a large volume, i.e., they will not sink to the bottom and accumulate there.

Here, the matrix materials may also be shaped such that they have specific load properties and/or geometric properties and are beneficial for multiaxial stress states or can be produced according to the dimensioning.

The essential advantages of the invention can be described as follows. The essential novel aspect consists in enabling the use of desert sand, which is a readily available resource but, due to its unfavorable properties, was hitherto ineligible for use as a building material. A further advantage is that material is sintered as needed through punctiform, i.e., local energy input, as is needed in this size. In addition, stepwise growing units of the grain agglomerate can be formed. According to an advantageous embodiment of the invention, the energy required for sintering is generated directly from solar energy and thus without complex and interference-prone transformation into other energy forms.

Due to the generation of a new resource, previous sand extraction methods become unprofitable, which bears particularly positive ecological advantages. The extraction of sand from rivers, lakes and coastal regions causes severe erosion of the coast and bank areas.

The use of solar energy avoids CO₂ emissions. Besides water and mineral binders, aggregates constitute the essential part of the concrete. Mineral binders have been modified for some time to impart special and individually adjusted properties to the final concrete product. Selective modification of the aggregate properties provides new opportunities here which are of enormous economic interest.

### BRIEF DESCRIPTION OF THE DRAWINGS

Further details, features and advantages of the invention become apparent from the following description of embodiments under reference to the associated drawings. In the schematic drawings:

FIG. 1 is a schematic perspective view of an embodiment of a sintering apparatus according to the invention;

FIG. 2 is a schematic side view of an embodiment of a dual sintering apparatus according to the invention; and

FIG. 3 is a schematic cross-sectional side view of an embodiment of a construction element according to the invention.

### DETAILED DESCRIPTION OF THE PREFERRED EMBODIMENTS

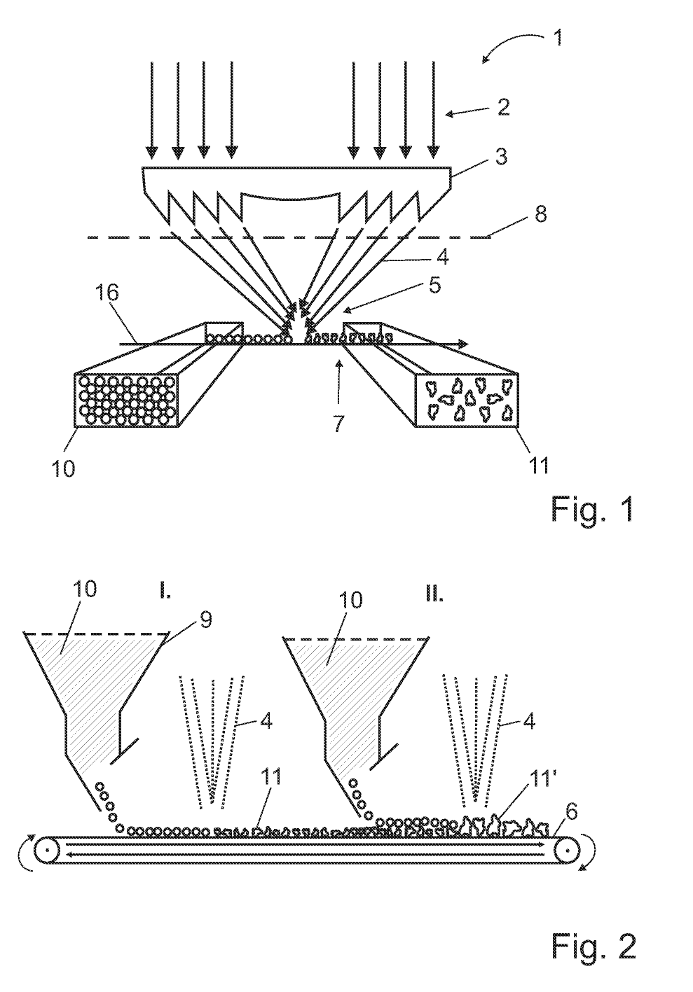

FIG. 1 shows the operating principle of an embodiment of a sintering apparatus 1 according to the invention. Sunlight 2 is collimated via a lens system 3, which in the shown embodiment is a Fresnel lens, and is focused at the focal point 5. The intensity of the collimated sun rays 4 can be adapted depending on the set position of an aperture 8, whereby the temperature to be reached at the focal point 5 can be adjusted variably.

Via a metering device, the sand 10, i.e., raw sand as the source material, is supplied to a temperature resistant conveyor device 16 made of or coated with a ceramic material and moving in the conveying direction 16. The sintering process takes place at the focal point 5 of the lens system 3 (and under pressure where needed).

As the conveyor device 16 proceeds further, the sintered sand 10, which has formed a grain agglomerate 11, cools down or, alternatively or additionally, is actively cooled down by a cooling device 7, which is not described and shown in more detail here.

FIG. 2 shows a schematic side view of a dual sintering apparatus according to the invention and particularly also the metering and conveying process of a multi-stage, in this case two-stage method. Areas I. and II. designate the two process stages. The sintering (see focused radiation 4) and cooling processes here systematically alternate in order to combine and sinter several layers of sand 10 successively supplied from the metering devices 9 with one another and with the grain agglomerates 11 of the previous stage, respectively, to form grain fractions, i.e., grain agglomerates 11, which grow larger with every process stage.

A conveyor device 6 moves the sand 10 relative to the focused radiation 4.

The waste heat released during the cooling can be returned, for example via energy recovery processes, to the transport system or the facility technology such that the entire system can be operated in a self-sufficient manner. Solar energy, which is used anyway, may also be used here, i.e., the entire facility technology may be designed to use solar energy.

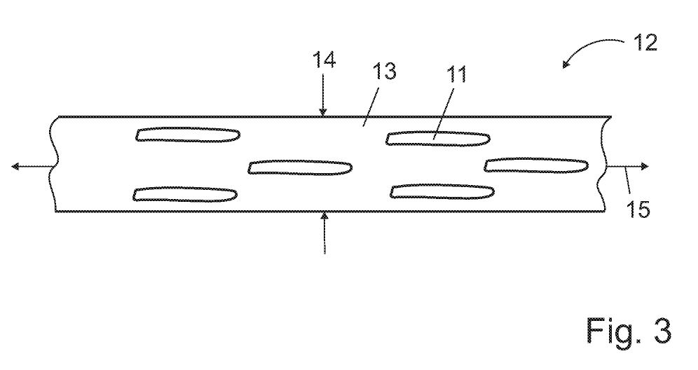

FIG. 3 is a schematic cross-sectional side view of an embodiment of a construction element 12 according to the invention. The construction element 12 comprises a matrix material 13. Said matrix material consists of hydrated cement and an aggregate directionally oriented according to need or required dimensions. According to the invention, the introduced aggregate consists in grain agglomerates 11 oriented in the direction 15 of tension of the construction element 12 to be formed.

A particularly advantageous variant provides grain agglomerates 11 which have a higher tensile strength than the matrix material 13 and thus have an effect similar to that of a fiber reinforcement. Together with the directionally oriented introduction into the matrix material 13, this results in a considerable increase in tensile strength of the construction element 12 in the direction 15 of tension.

### LIST OF REFERENCE NUMERALS

1 sintering apparatus

2 radiation, solar radiation, sun rays, sunlight

3 focusing device, lens system, Fresnel lens

4 focused radiation

5 focal point

6 conveyor device, positioning device

7 cooling device

8 aperture

9 metering device

10 sand, sand grain, desert sand

11, 11′ grain agglomerate

12 construction element

13 matrix material

14 direction of compression

15 direction of tension

16 conveying direction

1. A method for the thermal treatment of sand, characterized in that a radiation (4) focused to at least one focal point (5), through which heat is created when meeting a surface, is directed onto a surface of a bulk sand (10), that the local temperature of the sand (10) is increased such that the crystal lattice structure of the SiO₂ compounds changes, and/or deformations and/or grain agglomerates (11) are created when a sintering temperature is reached.

2. The method according to claim 1, wherein the change in the crystal lattice structure is followed by at least one further method stage of sintering.

3. The method according to claim 1, wherein free sintering, in which the focal point (5) is directed onto the surface of the bulk of the sand (10) in an appropriate manner, results in grain agglomerates (11) having the intended dimensions.

4. The method according to claim 1, wherein mold sintering, in which the focal point (5) is directed in an appropriate manner onto the bulk of the sand (10) introduced into a temperature resistant sintering mold which is open towards the top, results in grain agglomerates (11) having the intended dimensions, so that a molded part is formed.

5. The method according to claim 1, wherein a selective and timed reduction of the temperature is provided after the sintering, so that the crystal lattice structure of the SiO₂ compounds is selectively influenced further.

6. The method according to claim 1, wherein the local temperature is increased or decreased stepwise or constantly by means of multiple focusing devices (3) successively supplying focused radiation (4) to the surface of the sand (10).

7. The method according to claim 1, wherein a device for utilization of solar energy provides thermal energy obtained through focused solar radiation (2), and a lens system acting as a focusing device (3) focuses the solar radiation (2) in a controlled manner, so that the usable amount of energy and the temperature at the focal point (5) of the lens system are continuously adjustable.

8. The method according to claim 7, wherein control is achieved through a continuously acting lamellar aperture or through application of a shutter technology in which the duration of exposure is changed by fully allowing and obstructing passage of the beam in alternating, sequential intervals at a predetermined frequency.

9. An apparatus for the thermal treatment of sand, wherein a focusing device (3) for a radiation (2), through which heat is created when meeting a surface, is provided for generating at least one focal point (5) on the surface of a bulk sand (10), wherein a device for utilization of solar energy comprising a lens or a lens system (3) is provided, characterized in that the device for utilization of solar energy focuses the solar radiation in a controlled manner such that the temperature at the focal point (5) of the lens or the lens system (3) is continuously and variably adjustable.

10. The apparatus according to claim 9, wherein a positioning device (6) is provided for continuous or discontinuous relative movement between the focal point (5) and the sand (10).

11. The device according to claim 10, wherein multiple lens systems (3) are provided and are arranged in such a manner that the temperature of the sand (10) can be changed stepwise or constantly during the continuous relative movement between the focal point (5) and the sand (10).

12. A reinforcement material for the construction industry, consisting of round-grain sand grains as the source material, characterized in that the sand grains (10) are agglomerated by sintering to form grain agglomerates (11) having a predetermined size distribution.

13. The reinforcement material according to claim 12, wherein grain agglomerates (11) shaped in a load and/or geometry dependent manner are provided.

14. The reinforcement material according to claim 12, wherein three-dimensional bodies or hollow bodies designed as a single- or multi-layer lattice or space lattice with variable lattice parameters are provided as the grain agglomerates (11).

15. Use of desert sand as an aggregate for a construction element (12), characterized in that coarse grain agglomerates (11) of desert sand (10) obtained by surface modification through thermal treatment according to claim 1 and/or by sintering are introduced as an aggregate into a matrix material (13).

16. The use according to claim 15, wherein sintered, freely shaped grain agglomerates (11) are incorporated in the matrix material (13) in a directionally oriented manner, so that the grain agglomerates (11) are present in the construction element according to load and required dimensions.
